(19) United States
(12) Patent Application Publication
(10) Pub. No.: US 2013/0015703 A1
(43) Pub. Date: Jan. 17, 2013

(54) MICROGRID

(71) Applicants: Gregory C. Rouse, Sarasota, FL (US); John F. Kelly, Elmhurst, IL (US)

(72) Inventors: Gregory C. Rouse, Sarasota, FL (US); John F. Kelly, Elmhurst, IL (US)

(21) Appl. No.: 13/184,538

(22) Filed: Jul. 16, 2011

(51) Int. Cl. H02J 3/38

(52) U.S. Cl. 307/18

(57) ABSTRACT

A microgrid is a portion of an electric grid configured for separate management and control as compared with the rest of the grid and having attributes that can be tailored to meet specified needs including the needs of electric power consumers served by the microgrid.

### BACKGROUND OF THE INVENTION

1. Field of the Invention

The invention relates to an electrical apparatus. In particular, an electrical grid including a network of electrical conductors is a part of a larger grid.

2. Discussion of the Related Art

One of the earliest electrical grids in the United States was established in 1886 in Detroit when the Edison Illuminating Company began serving its first customers by distributing electricity for street lamps and factories in and around Detroit. Edison was a proponent of direct current electrical generation and distribution but this technology was quickly replaced by alternating current and its ability to be transformed to supply different voltage appliances and to be boosted to recover voltage lost during transmission over long distances.

Modern day electric grids tend to have very high AC transmission voltages for traversing long distances and intermediate AC distribution voltages for supplying power to smaller areas. Grid development has been largely driven by sites of power generation, areas of dense population, and more recently by interconnection of disparate grids to increase grid reliability.

Given that grids are designed and built by utility companies scattered across this and other countries, standardized grid designs are virtually unknown. Grid development is therefore a complex process that enlarges what has become, at least in the United States, an increasingly uncoordinated electric supply system.

There is a need for better coordination of the electric supply system in the United States including standardization of grid design that provides for more straightforward interconnection and coordination of disparate grids and improves grid reliability and control.

### SUMMARY OF THE INVENTION

The present invention provides a microgrid for use with one or more power sources such as grid interconnections. In various embodiments, the microgrid is designed to receive power from at least two power sources such as independent power sources. When a microgrid power source experiences an outage, the microgrid is designed to operate on the remaining power source(s).

In an embodiment an electric grid comprises a plurality of grid sections and at least one of the grid sections is a microgrid; the microgrid is configured to receive electric power at first and second microgrid interconnections; a first edge substation interconnects the microgrid first interconnection with a first source of electric power; a second edge substation interconnects the microgrid second interconnection with a second source of electric power; and, the microgrid is separable from one or more other sections of the grid.

In some embodiments, the electric grid further comprises a plurality of distribution circuits extending between the substations of the microgrid; one or more sectionalization switches are operative to interrupt the flow of electric power in one or more distribution circuits; and, upon the occurrence of a fault in a sectionalized distribution circuit, the sectionalization switches operative to interrupt the flow of electric power to the fault.

Further information about protective devices and systems together with explanations of electrical system faults is provided in U.S. Pat. App. No. 2004/0027748 A1 which is now incorporated herein in its entirety and for all purposes. In particular, the discussion of faults, protective devices, and protective device functions found in the abstract, summary, FIGS. 18-23, and the text relating to FIGS. 18-23 is included.

In an embodiment, an electric grid comprises a plurality of grid sections; at least one of the grid sections is a microgrid; an edge substation of the microgrid selectively interconnects a substation bus to an electric supply grid or a local generator; for each of a plurality of distribution circuits, a first switch connects one end of the circuit to the bus and a second switch connects another end of the circuit to the bus; for each of the plurality of distribution circuits, one of the first and second switches being closed and the other of the first and second switches being open; one or more sectionalization switches is operative to bifurcate one of the plurality of distribution circuits; and, upon the occurrence of a fault in a sectionalized distribution circuit, one or more of the sectionalization switches operative to interrupt the flow of electric power to the fault.

### BRIEF DESCRIPTION OF THE DRAWINGS

The present invention is described with reference to the accompanying figures. These figures, incorporated herein and forming part of the specification, illustrate the present invention and, together with the description, further serve to explain the principles of the invention and to enable a person skilled in the relevant art to make and use the invention.

FIG. 1 shows a block diagram of a microgrid in accordance with the present invention.

FIG. 2 illustrates a microgrid with two external power sources and two substations in accordance with the microgrid of FIG. 1.

FIG. 3 illustrates a microgrid with sectionalizing switches in accordance with the microgrid of FIG. 1.

FIG. 4 illustrates a microgrid with distribution line looping in accordance with the microgrid of FIG. 1.

FIG. 5 illustrates a microgrid with distributed generation in accordance with the microgrid of FIG. 1.

FIG. 6 illustrates a microgrid with a single external feed in accordance with the microgrid of FIG. 1.

FIG. 7 illustrates a microgrid utilizing a stored energy power source in accordance with the microgrid of FIG. 1.

FIG. 8 illustrates a microgrid with a grid connected converter in accordance with the microgrid of FIG. 1.

FIG. 9 illustrates a microgrid with a generator connected converter in accordance with the microgrid of FIG. 1.

FIG. 10 illustrates a microgrid with distributed converters in accordance with the microgrid of FIG. 1.

FIG. 11 illustrates a microgrid with power conditioning devices in accordance with the microgrid of FIG. 1.

FIG. 12 illustrates a microgrid utilizing DC power in accordance with the microgrid of FIG. 1.

FIG. 13 illustrates a microgrid with a master controller in accordance with the microgrid of FIG. 1.

### DETAILED DESCRIPTION OF THE PREFERRED EMBODIMENTS

A microgrid is a subsection of the grid that can be separated either temporarily or permanently from the rest of the grid, the grid subsection being configured for interconnection with at least two sources of electric power. Power sources includes one or more of grid feeds from distribution or transmission circuits, generation sources such as solar/photovoltaics or natured gas fired engines, and a combination of local generation and grid feeds.

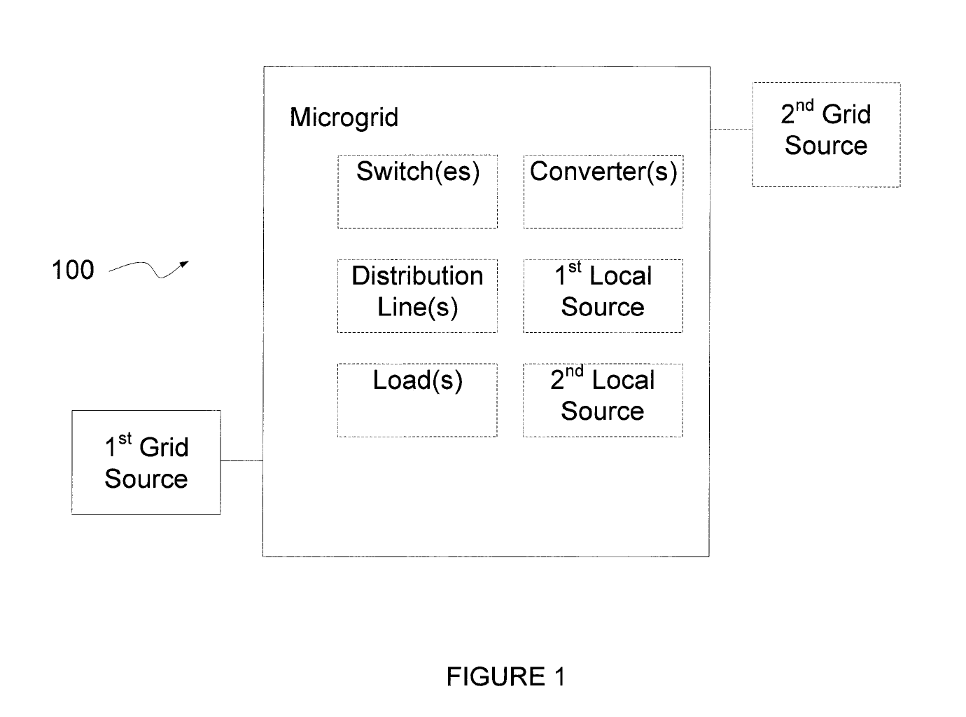

FIG. 1 illustrates a block diagram of a microgrid 100. The microgrid includes one or more of switches, distribution lines, loads, converters, local power sources, and grid power sources. For example, some microgrids include switches, distribution lines, loads, a Pt external power source and a 2^{nd} external power source. This and other embodiments of microgrids in accordance with the present invention are disclosed below.

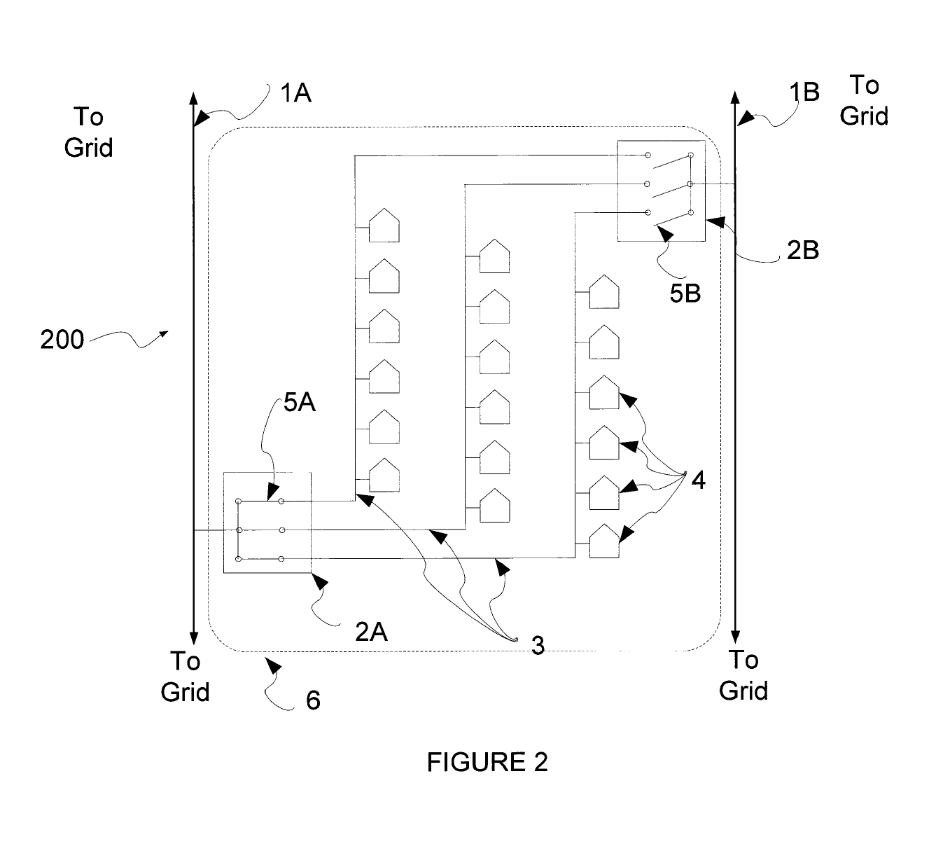

FIG. 2 illustrates a single line diagram of a first microgrid 200. The single line diagram includes grid feeds 1A, 1B, substations 2A, 2B, distribution conductors 3, and loads 4. A dashed line indicates a boundary 6 surrounding the microgrid.

In various embodiments, grid feeds 1A, 1B are interconnected grids such as distribution lines from a utility company or another provider connected to the bulk grid.

Substations 2A, 2B typically distribute power from transmission or distribution sources and include one or more of conductors, transformers such as transformers to step-down voltages from high voltage lines and circuit interrupters such as circuit breakers, fuses, or switches for protecting the distribution lines within the microgrid. In some embodiments, a substation may consist primarily of distribution buses or circuit breaker panels to distribute the power. Notably, in this patent application, the words connect, couple, and similar words such as interconnect, connected, and coupled refer, unless otherwise noted, to direct and indirect linkages, with or without intervening elements or parts. For example, “a substation connected to a grid” may be directly or indirectly linked, such as with or without an interposed transformer.

As shown, the substations 2A, 2B are configured to provide power from two independent power sources 1A, 1B in case feeds to one of the substations fails. In various embodiments, only one substation 2A, 2B powers the microgrid while the other is in a standby mode. For example, the first substation 2A breakers 5A are closed to supply microgrid power while the second substation 2B breakers 5B are open so that a short circuit is not created.

In this and other embodiments disclosed herein, one or more substations of a microgrid may be bi-directional. For example, in an embodiment a microgrid interposed between two grids transfers power from one grid to the other grid when a substation that normally imports power to the microgrid is used to export power from the microgrid. In another example, a microgrid interposed between a grid and a local power source exports power to the grid when a substation that normally imports power to the microgrid is used to export power from the microgrid.

The distribution conductors or distribution lines 3 provide power from the substations 2A, 2B to the loads 4. These loads can be homes, buildings, buildings with smaller loads contained within them, or a large load such as a chiller plant that supplies chilled water to a building(s) or campus. In the embodiment shown 200, the power flow and the power flow direction are controlled by the switches or breakers in the substations. Notably, control of power flow and power flow direction in more complex embodiments described below may differ.

Other equipment may be installed to stabilize voltages, power factors, and manage power quality within the microgrid 200. In various embodiments, microgrids utilize different sources of electric power that may include or exclude a grid. For example, microgrids may be designed to operate a) on single phase AC, b) on multiple phase AC, c) at frequencies other than 60 Hz (standard utility transmission and distribution frequency in the United States), or on direct current (DC).

Notably, the microgrid 200 can be electrically isolated from other sections of the grid. For example, opening the substation switches 5A isolates the microgrid from the grid section associated with the first external power supply 1A. In a similar fashion, opening the substation switches 5B isolates the microgrid from the grid associated with the second external power supply 1B. As a person of ordinary skill in the art will appreciate, similar switching arrangements present in other embodiments of the invention provide similar electrical isolation.

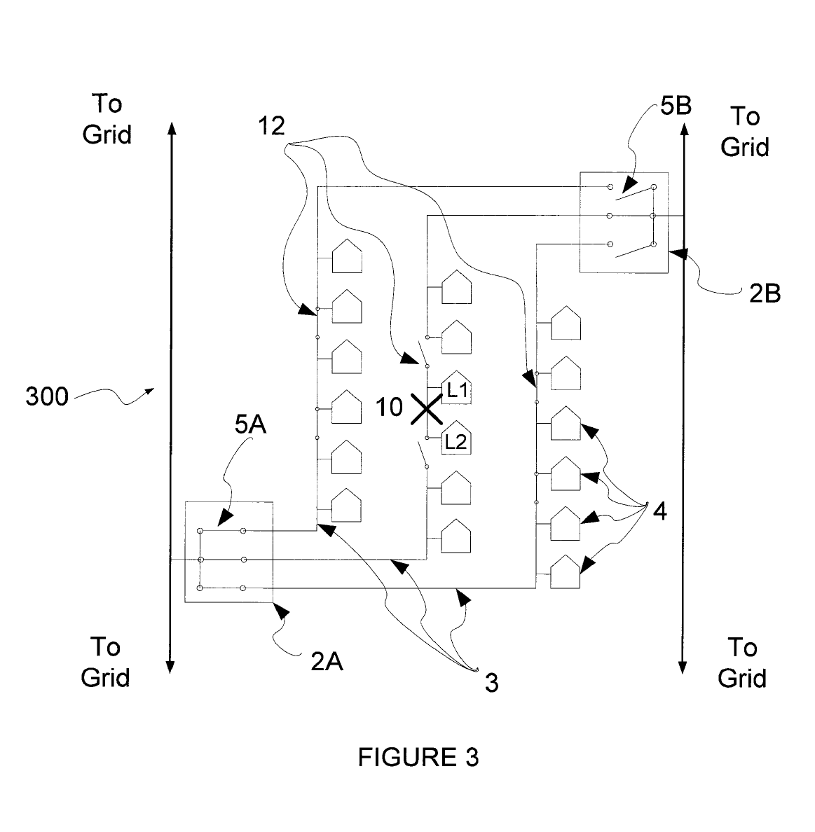

FIG. 3 shows a microgrid with section isolation fault protection 300. In this embodiment, sectionalizing switches 12 are included in one or more of the distribution lines 3. If a fault 10 should occur in a protected distribution line, the sectionalizing switches allow the faulted section of the distribution line to be isolated and at the same time allow power to flow to the sections that are not faulted. In this example, two sectionalizing switches 12 surrounding a fault 10 are opened to isolate the faulted section carrying loads L1, L2. Before the fault, all of the power on the faulted distribution line came from Substation 2A. After the fault, the faulted distribution line is feed from substations 2A and 2B as indicated by the position of the substation breakers 5A, 5B.

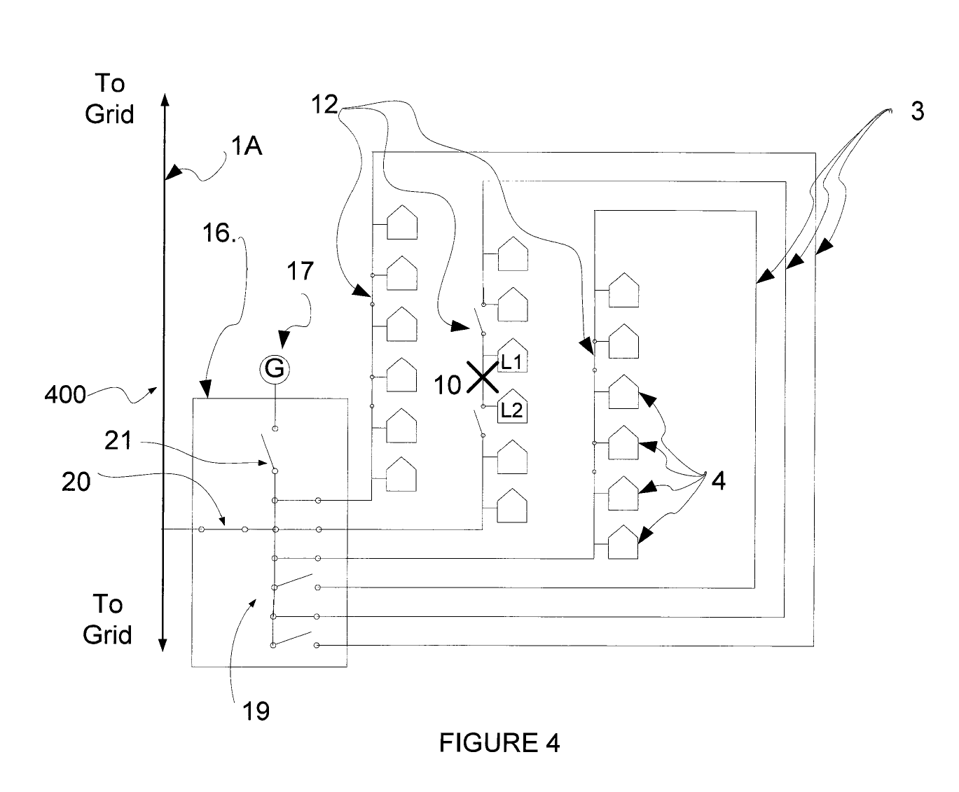

FIG. 4 shows a microgrid with distribution line looping 400. Here, a single substation 16 is interconnected with two power sources 1A, 17 via switches 20, 21 and the distribution lines 3 loop back to substation feeder breakers 19. Looping back refers to each end of a distribution line being connected to a respective feeder breaker in the same substation.

In the loop back configuration, power can flow into either end of a distribution line 3, i.e., from two directions. However, irrespective of the power flow direction, the power is supplied from the same substation 16 rather than from two separate substations. In an embodiment, local generation 17 supplies power to the substation during grid feed 1A outages illustrating the utility of two independent sources of power. Substation interconnection switches 20, 21 allow the power source for the main substation to be switched between the grid 1A and local generation 17. In order to avoid a short circuit, the source that is not used should be disconnected from the microgrid.

In the event of a fault 10, sectionalizing switches 12 are operative to isolate the faulted section of the distribution line and its loads L1, L2. When the faulted distribution line is cleared by isolating the fault, loads to either side of the faulted section of the distribution line can be fed by closing the feeder breakers 19 at each end of the faulted distribution line.

The local generation 17 can also be replaced by a feed from another power source such as a different grid source so that the microgrid maintains redundant power supplies. Another suitable power source is a feed from another substation in the same microgrid that is feed by an independent supply. In the latter instance, an enlarged microgrid can be constructed by chaining together substations with looped distribution circuits, the microgrid being maintained as long as the microgrid as a whole has two independent sources of power.

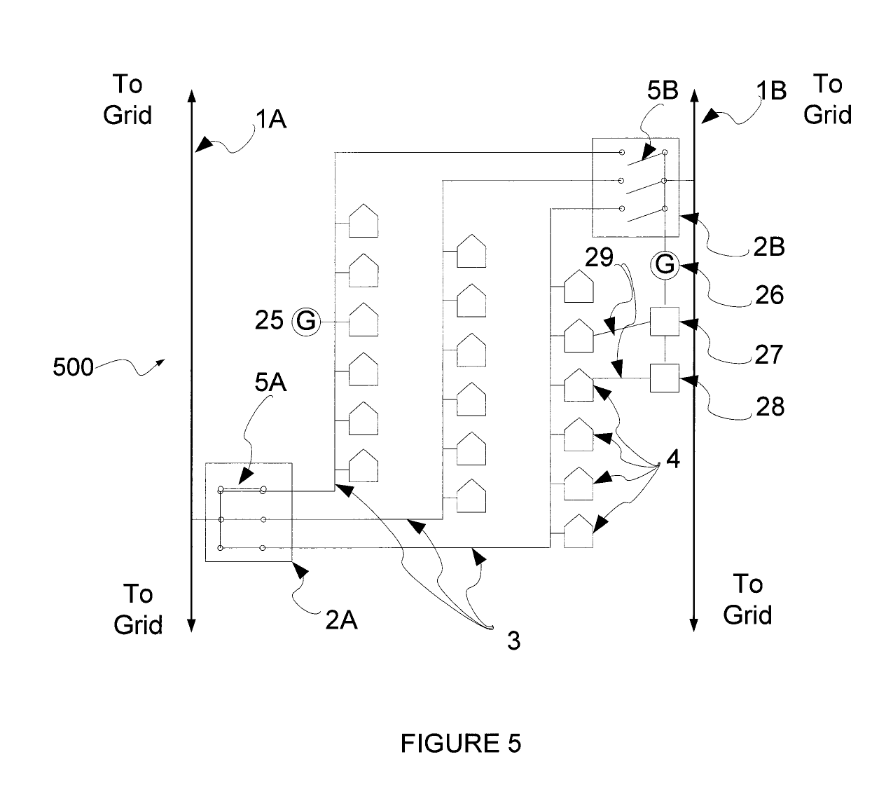

FIG. 5 shows a microgrid with distributed generation 500. Distributed generation power sources include renewable and fossil fueled power sources such as solar photovoltaic and natural gas fired engines. In various embodiments, generation is installed at one of the distribution lines 3 or at one of the substations 2A, 2B. An advantage of installing generation on a distribution line is that it can provide voltage support along the line. The generation can also be isolated with circuit breakers 5A, 5B or sectionalizing switches 12 (See FIG. 4) to provide power to critical loads during a grid outage. For generation installed on distribution lines, generation capacity can be limited by the size of the distribution conductor and one generator may not be able to supply power to the entire microgrid. For this reason, in some embodiments it is advantageous to install generation on a substation bus. When installed on the substation bus, the generated power can be distributed through the substation.

There are several reasons for installing generation within a microgrid. One reason is to increase power security and reliability, so that when the grid supply is interrupted, the generation or local power source can act as a back-up power supply to the microgrid by electrically isolating the microgrid from the bulk grid and supplying power from the local generation.

Another reason is to reduce costs. If power can be generated locally on the microgrid at a lesser cost than a grid supply, then the microgrid operator can save money by utilizing generation from within the microgrid.

There may also be environmental reasons for generating within the microgrid. For instance, if electricity on the grid is primarily generated from coal fired plants, engines such as local natural gas engines might have a lower emissions and carbon footprint than the grid.

Local generation may also be beneficial when there is an abundant supply of a local fuel source. For instance, if a particular industrial, commercial, or biological process generates methane, the methane can be collected, stored, and burned in a gas fired engine. Depending on the quantity and the steadiness of the methane flow, the generation may only be operated periodically.

Local generation sources 25, 26 may also produce thermal energy that can also be utilized within a microgrid service area or sold outside this area. An example would be a combined heat and power system including a natural gas fired turbine, and a heat recovery system 27 on the exhaust of the turbine. The recovered heat can be used to create hot water, steam, or to heat another thermal transfer fluid. The recovered heat can be used to heat a building or to provide heat to other processes. One such process could be to provide heat to an absorption chiller 28 which can create chilled water from a high temperature heat source such as hot water. In various embodiments, the buildings are heated or cooled through thermal paths 29.

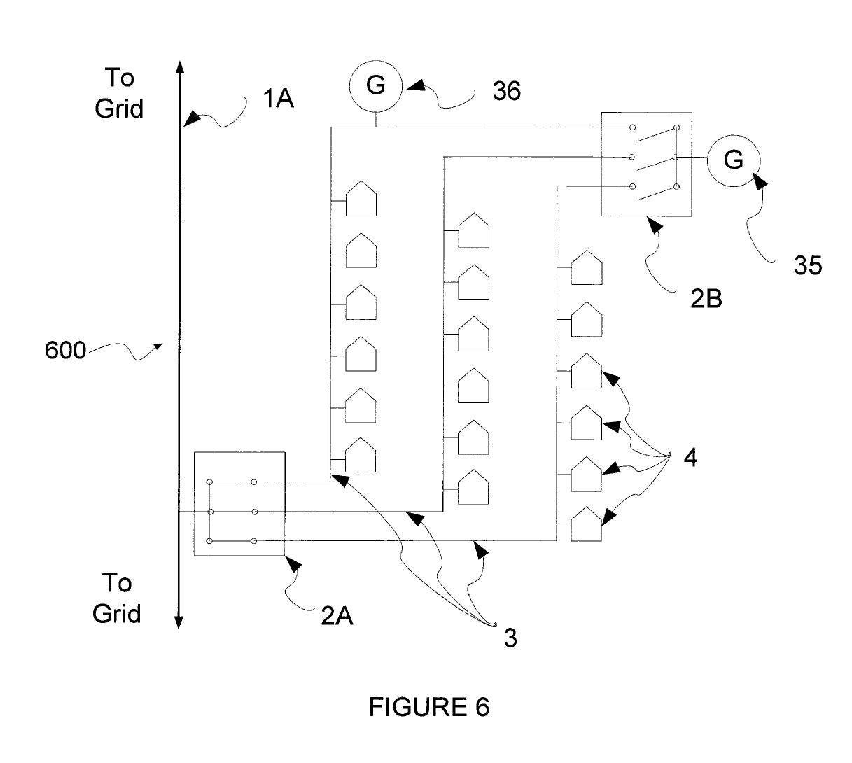

FIG. 6 shows a microgrid having a single utility feed 600. Here, only one substation 2A is supplied by a grid power source 1A. The other substation 2B is supplied by a local generator power source 35. In various embodiments, the distribution lines are supplied with power from one or more local generators 36. Some microgrids may be completely independent from the grid. For example, one embodiment replaces the grid feed 1A with a generator such as a local generator.

In other embodiments, stored energy can be used to supply power to the microgrid as an alternative to a grid feed 1A or generation 35, 36. In some such embodiments, generators are replaced with batteries and DC to AC converters for supplying AC power to the microgrid.

In this and other embodiments disclosed herein, one or more converters of a microgrid may be bi-directional. For example, in an embodiment a microgrid interposed between two grids transfers power from one grid to the other grid when a converter that normally imports power to the microgrid is used to export power from the microgrid. In another example, a microgrid interposed between a grid and a local power source exports power to the grid when a converter that normally imports power to the microgrid is used to export power from the microgrid.

As used in the patent application, the term “converter” refers to a device for converting between alternating and direct current. The term includes AC to DC devices, DC to AC devices, AC to AC devices, and DC to DC devices. As indicated by context of use, the term may refer to inverters (DC to AC), to rectifiers (AC to DC), and to switched semiconductor devices that construct particular waveforms including sinusoidal waveforms.

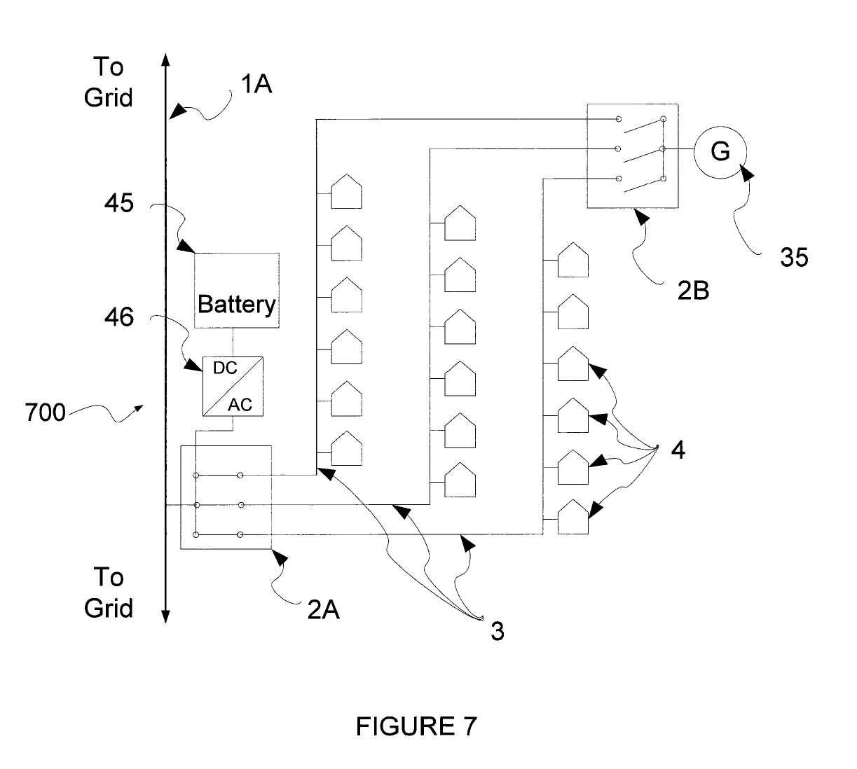

FIG. 7 shows a microgrid utilizing a stored energy power source 700. Energy storage devices include batteries, super capacitors, flywheels, and other such devices known to persons of ordinary skill in the art. In the embodiment shown, energy is stored in a battery 45 and a power converter 46 is interposed between the battery and a substation 2A. Notably, the power converter may be a unidirectional device converting DC to AC to feed the substation or it may be a bidirectional device capable of feeding the substation (converting DC to AC) and capable of charging the batteries from the substation (converting AC to DC).

In the embodiment shown, the power converter 46 is a bi-directional converter that converts electric power from AC to DC to charge the batteries and DC to AC to supply the microgrid with power from the batteries. The bi-directional converter 46 can be used to charge the batteries from a generation or grid source. At other times of the day, power can be supplied from the batteries.

The benefits of charging the batteries at particular times of day include the possibility of taking advantage of electric power pricing differences throughout the day. For instance, if the microgrid has access to dynamic or time of use electric rates from the grid, the batteries can be charged when the prices are low (typically at night) and discharged when the prices are generally the highest throughout the day. Another circumstance where this approach would be beneficial is when solar photovoltaic arrays can be used to charge the batteries during the day, and the batteries are discharged during the night or when electricity prices are expected to peak during the day. Another reason for adding energy storage is for microgrid reliability and energy security. The energy storage can be used to supply power while backup generation is being started.

Up to this point, only basic elements of the invention have been discussed. However, other components may need to be added to make these concepts work together. For instance, up to this point, this description has not included a discussion on synchronization between power sources or power conditioning. If the microgrid distributes alternating current (AC), then generation sources, DC to AC converters, and other AC power sources must be synchronized.

Power sources need to be synchronized with one another in order to work properly and prevent damage to interconnected equipment. If an AC generator is to be interconnected with an AC network, the generator must have its line voltage, frequency, phase sequence, phase angle, and waveform equal to that of the network. Suitable interconnecting networks include the grid and electric generators.

When the microgrid operates in parallel with the grid, the grid will provide a stable frequency. When the microgrid is operated independent of the grid (island mode), the generation source and DC to AC power converters must be synchronized. In various embodiments, a relatively large interconnected generator acts as a master and logic controlling interconnected smaller generators is able to interpret information from the microgrid phase waveforms and adjust the related small generator frequencies so they remain synchronized with the larger generator. Another approach uses communications between the inverters, power converters, and generators to maintain synchronization. Here, one generation source, power conditioner, or DC to AC power converter acts as a master and the other generation sources, power conditioners, or DC to AC power converters will follow synchronization commands to remain synchronized with the master.

Synchronization communication may take several forms. In various embodiments, synchronization communications include one or more of direct interpretation of the sinusoidal waveforms from the master generator or grid, communication of synchronization commands over wires, fiber optics, infrared, and radio frequency.

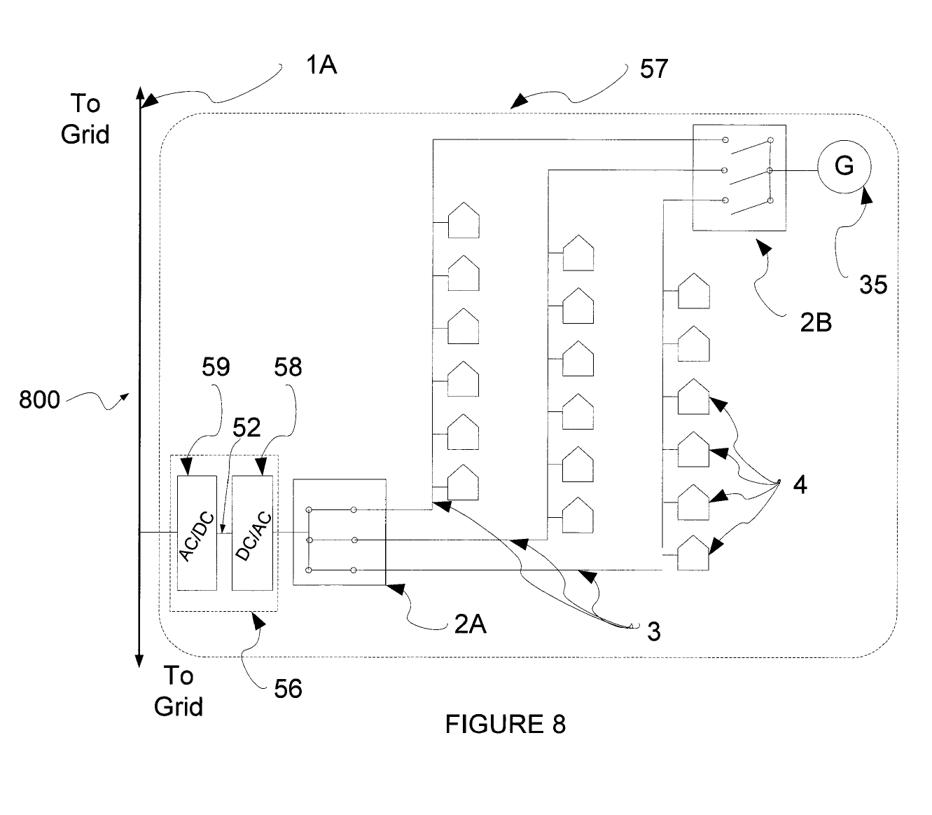

FIG. 8 shows a microgrid with a grid connected AC/AC converter 800. Here, a DC bridge 52 interconnects an AC/DC converter 59 coupled to a grid 1A and a DC/AC converter 58 coupled to a microgrid substation 2A. The interconnected converters 56 provide an AC/AC converter.

In an embodiment the AC/AC converter 56 is connected to the bus in one of the substations. In other embodiments, separate AC/AC converters are connected to the grid 1A and the distribution lines 3. In an embodiment, the AC/AC converter provides for bi-directional power flow. In one operating embodiment, while power flows from the grid to the microgrid 57, the first converter 58 converts the AC power from the grid to DC power. The second converter 59 receives DC power from the first converter 58 and converts it back to AC. One advantage of this approach is that the microgrid need not be synchronized with the grid 1A because the DC bus 52 eliminates the need for synchronization. In addition, the bus voltage and frequency can be different than the grid voltage and frequency. Yet another advantage of the AC/AC converter is that synchronization of the grid and microgrid, if needed, can be coordinated through the converter 56 which is often easier to control than a generator. For the purpose of synchronizing the microgrid to the grid, the generator or local power source 35 in various embodiments communicates with the converter 56 to coordinate their respective frequencies until they are synchronized.

It should be noted that in this, and in other embodiments utilizing converters interposed between a grid section and the microgrid, the converter provides a means of isolating the microgrid from the grid section.

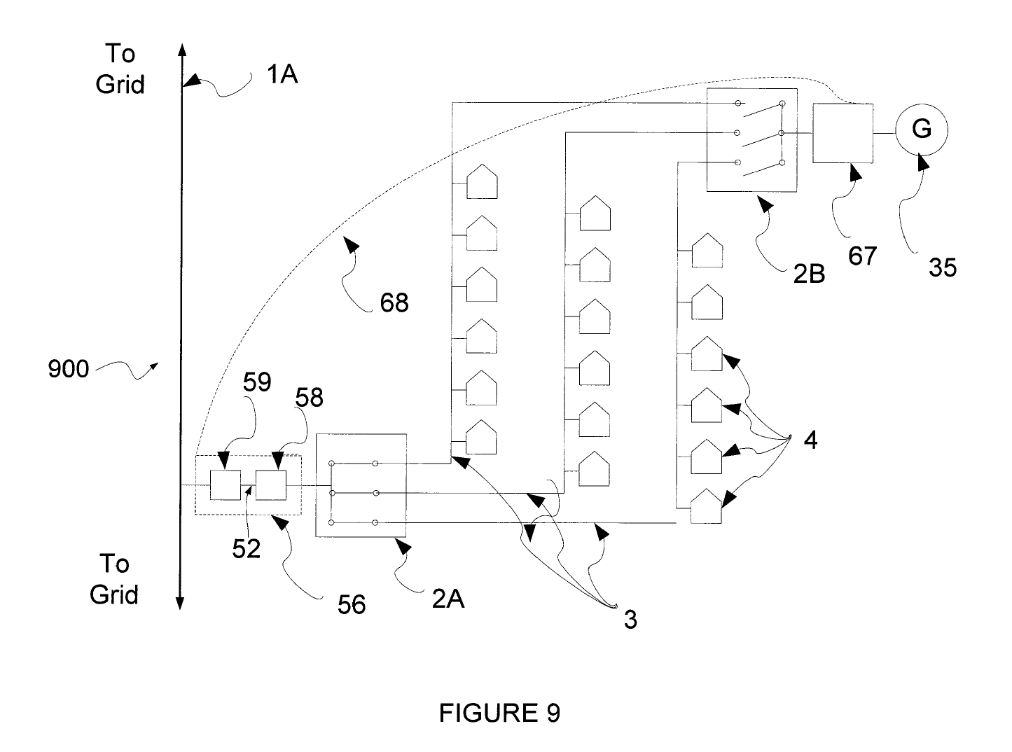

FIG. 9 shows a microgrid with a generator connected converter 900. In various embodiments a converter 67 is an AC/DC converter and in various embodiments the converter is an AC/AC converter. For example, an AC/AC converter connects a source 35 such as an AC generator to a microgrid substation 2B. In other embodiments, an AC/DC converter connects DC power sources such as a battery or solar photovoltaic cells, to a microgrid substation 2B.

The converter 67 can also be used to decouple certain aspects of the generator from the rest of the microgrid. Through this decoupling, the generator can operate at a different frequency and different voltage from the microgrid. For example, gas fired generators can be designed to operate more efficiently as variable speed machines and this decoupling allows for their use. In various embodiments a communications line 68 enables communications between the converters 56, 67.

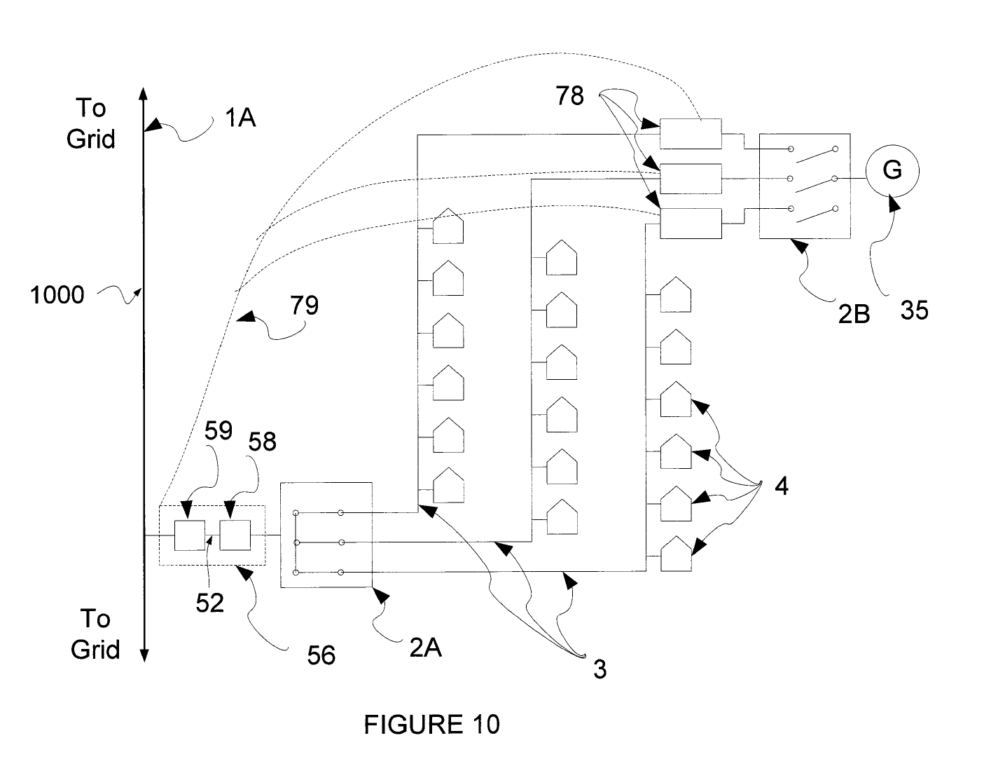

FIG. 10 shows a microgrid with distributed converters 1000. Here, distributed converters 78 are interposed in each distribution line 3 between the corresponding loads 4 and a microgrid substation 2B. In various embodiments, a DC power source 35 provides power to the substation 2B and the converters 78 are AC/DC converters for converting the supplied DC power to AC power for supplying the loads. And, in various embodiments, an AC power source 35 provides power to the substation 2B and the converters 78 are AC/AC converters for supplying AC power to the loads.

An advantage of this arrangement is that some of the functions of the substation 2B, such as current limiting and short circuit protection, can be replaced by the inverters 78. In some embodiments, the inverters are designed to control the power flow to the distribution lines 3 and to provide protective controls, such as short circuit protection, normally contained in a substation. Various embodiments utilizing the inverters to provide protection typically found in the substation enable the use of less expensive substation breakers and relays.

Since generation is a voltage source, generation distributed on the microgrid can be used to stabilize voltages and power quality on the microgrid while the microgrid operates in parallel to the grid. Inverters also work to stabilize disturbances and improve power quality on the microgrid as their primary function is to create sinusoidal AC waveforms for the microgrid. Depending on the design of the microgrid and whether or not microgrid loads may cause power surges or add harmonics on the distribution lines, equipment may be required to enhance power quality on the microgrid. In various embodiments, a communication line 79 enables communications between the converters 56, 78.

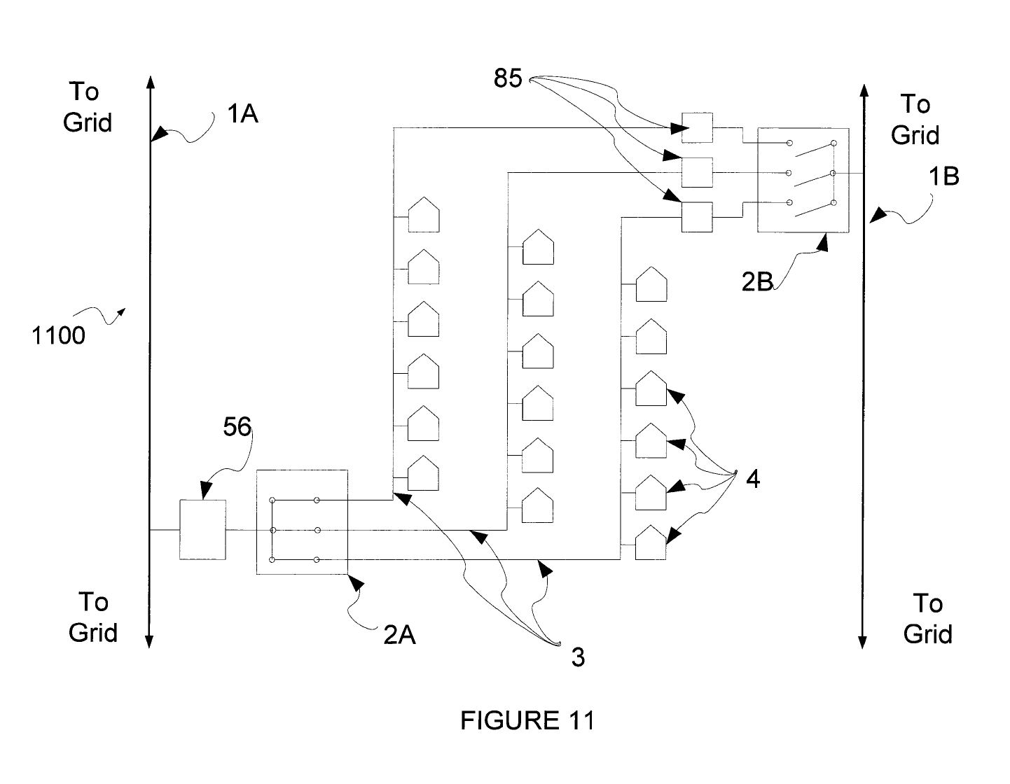

FIG. 11 shows a microgrid including power conditioning devices 1100. Here, the power conditioning devices 85 may include one or more of advanced power electronics, capacitor banks, inductive banks, and resistor banks to remove disturbances from the AC waveform. Disturbances may be from the grid 1A, 1B or they may be caused by particular loads 4 within the microgrid. As mentioned above, converters may also accomplish this function.

As shown, one power conditioning device is dedicated to each distribution line. In various embodiments, power conditioners are placed between loads or between loads and the distribution lines.

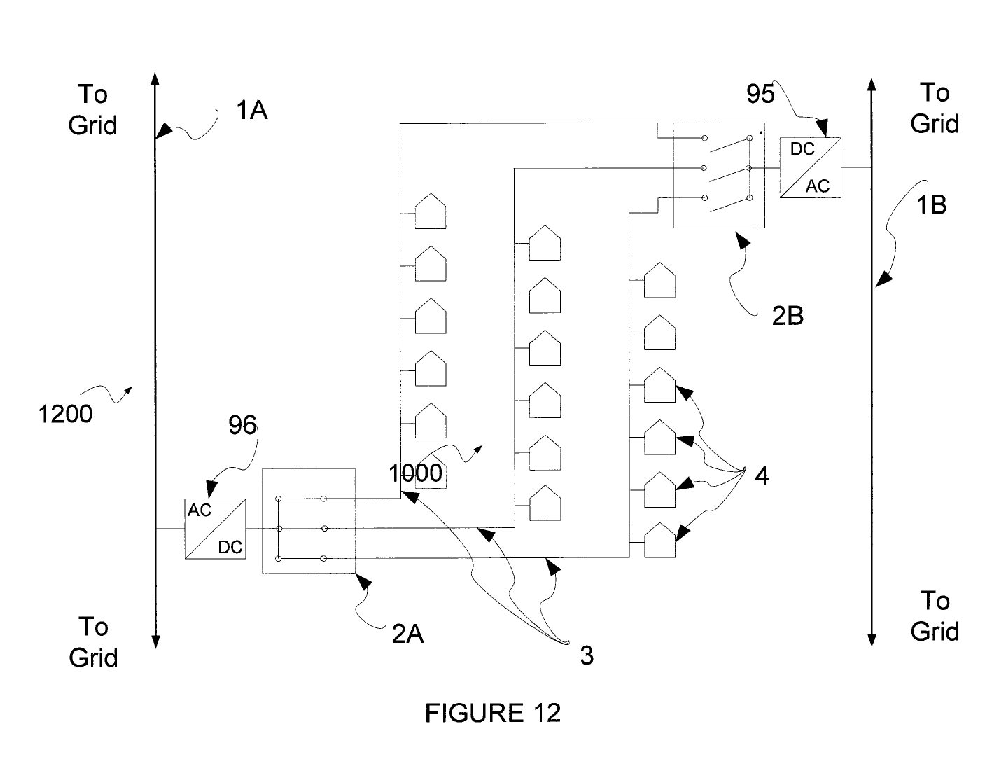

FIG. 12 shows a DC microgrid 1200. Here, bi-directional converters 95, 96 convert AC power from the grid 1A, 1B to DC power that is supplied to the microgrid. Substations 2A, 2B provide protection for the distribution lines 3. In various embodiments, DC microgrids provide efficiency benefits such as use, without conversion, of DC sources such as photovoltaics.

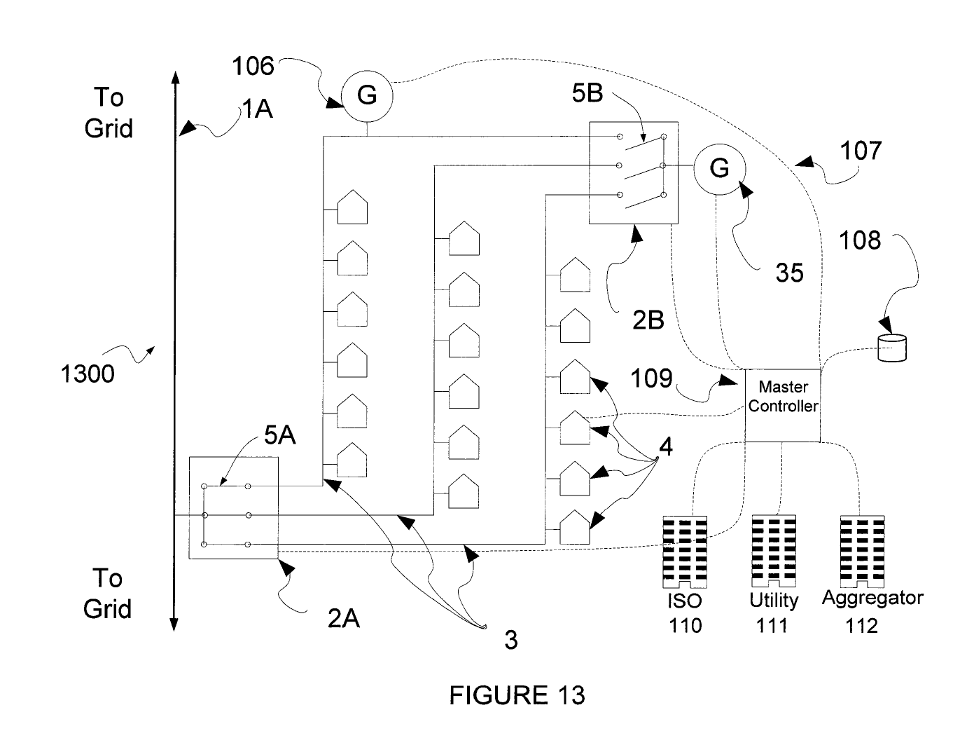

FIG. 13 shows a microgrid including a master controller 1300. Here, the master controller 109 maximizes the benefits of a microgrid by coordinating the control of devices in the microgrid with each other and with the external devices outside of the microgrid including power sources and data sources such as weather data sources and independent system operator data sources. In an embodiment, the master controller communicates through communication pathways 107 to devices on the microgrid. Such devices include the distribution system, local generation, building controls, home automation devices, converters, and other devices for managing the microgrid.

In various embodiments, communications paths 107 within the microgrid interconnect the master controller with one or more of local power sources 35, 106, building load controllers, home automation devices in the microgrid loads 4, and the distribution system through the substations 2A, 2B. Communications path media includes one or more of wires, fiber options, and radio waves.

In various embodiments, communication to other servers and data sources outside of the microgrid occurs. External data sources include price and demand response signals from the local utility 111, the ISO 110, or an aggregator 112. In some embodiments, the master controller collects weather data and weather forecasts from an outside data source. The weather prediction is useful for predicting grid loads and the amount of generation produced locally from solar and wind generation sources. The local utility may sell the microgrid power using time of use pricing where the price depends on the hour of the day. The utility may also sell the microgrid power based on real time pricing which can change as often as every five minutes depending on transactions in the wholesale electricity markets and day ahead prices which typically change every hour and are determined the day before in a special day ahead electricity market.

The ISO 110, known as the Independent System Operator, refers to the entities that run the electricity markets in the United States. Not all states within the US are deregulated and as such they do not participate in an ISO. Currently, ten Independent System Operators and Regional Transmission Organizations (ISO/RTOs) in North America serve two-thirds of electricity consumers in the United States and more than 50 percent of Canada's population. Some ISOs only serve one particular state such as the NYISO which only servers the state of New York, while others such as the PJM server several states along the Atlantic Coast and the Midwest. Notably, some states are served by multiple ISOs.

A microgrid can also strike a business deal with an ISO, either directly or through a third party to purchase blocks of power at a fixed price, to participate in real time markets set up by the ISO, and to participate in day-ahead markets. The ISOs also setup other markets, called ancillary services, which are intended to help stabilize the bulk grid in the ISO's territory. The microgrid may also be able to participate in these ancillary markets which tend to evolve over time. Some of the ancillary services that microgrids can potentially participate in are demand response where the participant agrees to reduce their load by a certain amount when called on to do so and capacity markets where the participant agrees to maintain generation sources and operate them to supply power to the grid when called to do so. Utilities may also offer ancillary services to the microgrid operator.

Additionally, aggregators or third party energy service providers 112 may offer different combinations of dynamic pricing or ancillary services to the microgrid, though the power would ultimately be purchased from the ISO. Dynamic pricing is a term for electric rates that change over the course of the day and includes, time of use pricing, real time pricing, and day ahead pricing.

In various embodiments, the microgrid controller 109 assists with coordination of the actions of the microgrid to a) maximize the economic benefits of participating in different electricity markets, b) improve the reliability and energy security of the microgrid, and c) reduce its environmental impact. The microgrid master controller operates in a mode suited to the external conditions. For example, when electric prices are relatively high, the master controller 109 requests that building loads be reduced or local generation be increased to reduce the amount of electricity purchased from the utility, ISO, and/or aggregator. In this example, the master controller determines the cost to produce the electricity locally and compares this with the cost of purchasing electricity from the grid; the microcontroller then selects the lowest cost option.

The master controller 109 can also be used to facilitate bidding and purchasing of electric power from a seller. This facilitation can be for purchasing primary power or ancillary services. The master controller will have the ability to predict the aggregate load for the microgrid based on models constructed from historical data. In various embodiments, these forecasts are submitted electronically to sellers who may bid on selling power to the microgrid. In addition, embodiments of the master controller 109 will have the ability to model the load shedding capabilities of the microgrid, through either load control, generation, or a combination of both. This information can be used to offer bids for taking part in demand response events.

In a weather watch mode, the master controller uses predicted weather information to predict generation available from solar and wind generation sources that is available to offset grid loads. Estimated grid power shortfalls are used in various embodiments to dispatch microgrid generation and to curtail microgrid loads.

In another weather watch mode, the master controller 109 determines that there is a severe weather threat from a source of weather information 108, such as a weather service, that could cause a grid outage. Weather and weather severity indicators include icing, wind speed, lightning, thunder storms, flooding, tornadoes, hurricanes, and microbursts. As indicated by the severity of the predicted weather, the master controller can choose to disconnect from the grid and dispatch local generation to meet at least some of the power supply needs of the micro grid. In this mode, the master controller also sends load reduction signals to the loads on the microgrid to balance power available to the microgrid with the total load on the microgrid.

In a demand response mode, the master controller 109 uses a combination of reducing loads on the microgrid and dispatching local generation to meet the demand response request. Whether generation or load reduction is used depends on the load reduction capability under the control of the master controller, the capacity of the generation, and the amount of load reduction requested in the demand response event. It is generally less expensive to reduce loads using load controllers than it is to dispatch fueled generation, but reducing loads solely through load reduction requests may have secondary costs such as loss of comfort, inconvenience, or spoilage.

In some embodiments, the master controller predicts the microgrid's response to load reduction command(s) with the prediction a) selecting loads to be curtailed with the associated KW curtailment and b) selecting local generation to be added with the associated KW addition. In various embodiments, the master controller selects loads/KW ratings and generation/KW ratings to achieve the commanded load reduction while meeting criteria set by a microgrid operator. In various embodiments, operating constraints include one or more of a) never curtail for certain loads, b) always run for certain generators, c) comfort level of building occupants, and d) preferences set by microgrid customers and/or consumers.

Additionally, in a demand response mode, the master controller 109 uses load models to predict how the microgrid and the loads on the microgrid respond to the demand response event depending on the time of year, time of day, and weather conditions. These load response models can be based on prior historical data stored in the database 108. Such load response models can also be built using data collected during times of testing. During tests, the master controller can perturb load or thermostat settings to learn the responses in different weather conditions, times of the day, and times of the year. These learned responses enable predictions of microgrid response which is useful for bidding into demand response markets and for determining what level of load reduction can be achieved. If a target load reduction level are not likely to be achieved, more drastic load reduction measures may be required.

In a cost reduction mode, the master controller 109 can dispatch local generation to reduce costs when the cost to purchase electricity is higher than the cost to generate electricity. Price forecasting models built from data stored in the database or data from day ahead electricity markets is used to estimate times when the price of electricity on the gird is above the price to of electricity generated local to the microgrid so that local generators can be prepared to start before they are actually required which is important when using generating devices that require relatively long startup times.

Similar to the demand response mode, load response modes can be used in the cost reduction mode to estimate the load reductions during periods of high prices and to estimate the electricity costs during an expected price increase. In some embodiments, this information is feed back into the system so that more aggressive measures can be taken if necessary.

Further, price forecasts can be used to predict when electricity prices will be above certain price thresholds that are set to trigger when certain load reduction actions are required on the microgrid. In some embodiments, the price forecasting data is combined with weather data and weather forecasts to help predict when prices and loads may be high. In the case of reducing cooling loads, pre-cooling can be used to lower the temperature of a building before prices are expected to increase so that the building can operate its air conditioning system less frequently during periods of high prices. And in some embodiments, other conservation measures are taken such as periodically sweeping lights and curtailing non-essential loads.

In various embodiments, depending on the capabilities of the distribution switches and breakers installed in the microgrid, the distribution system autonomously heals itself when a distribution outage occurs. In some embodiments, this function is handled by the master controller 109. Here, the master controller 109 sends commands to the substation breakers in 5A, 5B and sectionalizing switches (see sectionalizing switches 12 of FIG. 2) to re-direct and coordinate the flow of power when a breakage in a distribution power conductor occurs or when loss of power occurs from one the microgrid power sources such as the grid 1A or local generation 35. Current and voltage sensors within the breakers and sectionalizing switches are operative to report currents and voltages back to the master controller giving the master controller an indication of where faults may have occurred and which distribution lines have power and which have faults. This information can then be used to position the sectionalizing switches and substation breakers to isolate sections where faults have occurred and to redirect power to fault free sections in need of power.

In an embodiment, the master controller includes a mode for reducing environmental impact. The actions taken in this mode will depend on the environmental characteristics of the local generation, the environmental characteristics of the grid, and the load reduction capabilities on the microgrid. Since they operate the electricity markets and know which generators in their system are running at any given time, each ISO can calculate the hourly environmental impact of the generators operating on its grid in real time. The environmental impact includes carbon production, air emissions, and can include water and other impacts. The environmental impact is retrieved by the master controller 109 which determines if it is better to operate its own generation sources to reduce the microgrid's external power demand given environmental preferences, comfort preferences, the cost to operate local generation, and the cost to purchase external power.

Many of the energy systems associated with the microgrid may have autonomous control over their respective systems and these autonomous controllers (sometimes called “agents”) can independently control their respective system. In this case, the microgrid master controller feeds these controllers external data such as weather data, price data, and demand response communications so that these systems can determine optimal solution sets between themselves.

In addition to providing supervisory control for the microgrid, various embodiments of the master controller collect data. For example, some embodiments of the master controller collect data that is useful for tracking microgrid events and microgrid performance. In particular, current and voltage data from the distribution system that is feed to the master controller enables tracking outage metrics such as SAIFI, SAIDI, and MAIFI, as well as power quality events. Power and emissions data can be stored and used to report the microgrids efficiency, the grids efficiency, power consumption, peak demand, fuel consumption, microgrid carbon and emissions production, grid carbon and emissions productions, the cost to generate power locally, and the cost to purchase power from the grid over different time periods such as daily, weekly, monthly, and annually.

The microgrid of the present invention provides control capabilities and/or ease of control not available from traditional grids. In particular, embodiments of the microgrid utilizing a master controller enable multiple benefits to be realized including one or more of reliability enhancement, market based operating decisions, optimizations based on customer and cost criteria, secure operating modes, and modes optimizing the microgrid operation in the context of a larger grid.

While various embodiments of the present invention have been described above, it should be understood that they have been presented by way of example only, and not limitation. It will be apparent to those skilled in the art that various changes in the form and details can be made without departing from the spirit and scope of the invention. As such, the breadth and scope of the present invention should not be limited by the above-described exemplary embodiments, but should be defined only in accordance with the following claims and equivalents thereof.

What is claimed is:

1. An electric grid comprising:
a plurality of grid sections;
at least one of the grid sections being a microgrid;
the microgrid configured to receive electric power at first and second microgrid interconnections;
a first substation interconnecting the microgrid first interconnection with a first source of electric power energizing a first grid section;
a second substation interconnecting the microgrid second interconnection with a second source of electric power energizing a second grid section; and,
the microgrid having isolation devices for selectively electrically isolating the microgrid from other sections of the grid.

2. The electric grid of claim 1 wherein the microgrid is also configured to supply electric power from at least one of the first and second microgrid interconnections.

3. The electric grid of claim 1 further comprising:
a plurality of distribution circuits extending between the substations of the microgrid;
one or more sectionalization switches operative to interrupt the flow of electric power in one or more distribution circuits; and,
upon the occurrence of a fault in a sectionalized distribution circuit, the sectionalization switches operative to interrupt the flow of electric power to the fault.

4. The electric grid of claim 1 further comprising:
a third source of electric power local to the microgrid and for supplying the microgrid; and,
the microgrid having isolation devices for electrically isolating the microgrid from one or more sections of the grid.

5. The electric grid of claim 4 wherein the microgrid is also configured to supply electric power from at least one of the first and second microgrid interconnections.

6. The electric grid of claim 5 wherein the third source of electric power is a combined heat and power system supplying electricity to a substation and heat for conditioning a living space associated with a microgrid load.

7. The electric grid of claim 5 wherein the third source of electric power supplies electricity to a distribution line.

8. An electric grid comprising:
a plurality of grid sections;
at least one of the grid sections being a microgrid;
a substation of the microgrid selectively interconnecting a substation bus to an electric source;
for each of a plurality of distribution circuits, a first switch for interconnecting one end of the circuit to the bus and a second switch for interconnecting another end of the circuit to the bus;
for each of the plurality of distribution circuits, one of the first and second switches being closed and the other of the first and second switches being open;
one or more sectionalization switches operative to bifurcate at least one of the plurality of distribution circuits; and,
upon the occurrence of a fault in a sectionalized distribution circuit, one or more of the sectionalization switches operative to interrupt the flow of electric power to the fault.

9. An electric grid comprising:
a plurality of grid sections;
at least one of the grid sections being a microgrid;
a first substation and a grid power source, the microgrid configured to receive electric power at the first substation from the grid power source;
a second substation and a local power source, the microgrid configured to receive electric power at the second substation from the first local power source; and,
the microgrid having isolation devices for selectively electrically isolating the microgrid from other sections of the grid.

10. The electric grid of claim 9 wherein the microgrid is also configured to export power from the first substation.

11. The electric grid of claim 9 further including:
a microgrid distribution line; and,
a second local generator, the microgrid configured to receive electric power at the distribution line from the second local generator.

12. The electric grid of claim 9 further including:
a DC power source;
a converter for converting DC to AC; and,
the converter operable to provide electric power to a substation from the DC power source.

13. The electric grid of claim 9 further including:
an AC to AC converter interposed between the first substation and the grid power source; and,
the AC to AC converter including a DC link interconnecting an AC to DC converter and a DC to AC converter.

14. The electric grid of claim 13 further comprising:
a plurality of distribution lines extending between the substations; and,
a plurality of converters, each converter located in a respective distribution line between a substation and loads connected to the distribution line.

15. The electric grid of claim 14 wherein the local power source is a DC source and each converter is a DC to AC converter.

16. The electric grid of claim 14 wherein the local power source is an AC source and each converter is an AC to AC converter having a DC bridge interconnecting an AC to DC converter and a DC to AC converter.

17. The electric grid of claim 16 further comprising a converter interposed between the local power source and the second substation.

18. The electric grid of claim 17 wherein the local power source is an AC source and the converter is an AC to AC converter with a DC bridge interconnecting an AC to DC converter with a DC to AC converter.

19. The electric grid of claim 17 wherein the local power source is a DC source and the converter is a DC to AC converter.

20. An electric grid comprising:
a plurality of grid sections;
at least one of the grid sections being a microgrid;
the microgrid configured to receive electric power from at least one of first and second grid power sources;
a grid-side converter being an AC to AC converter with a DC bridge interconnecting an AC to DC converter and a DC to AC converter;
a first substation interconnecting the AC to AC converter and a first microgrid interconnection;
a plurality of distribution lines extending between the first substation and a second substation;
a plurality of load-side converters, each converter located in a respective distribution line between a second substation and loads connected to the distribution line; and,
the microgrid having isolation devices for electrically isolating the microgrid from one or more sections of the grid.

21. The electric grid of claim 20 wherein the microgrid is also configured to export electric power from at least one of the grid side converter and the second substation.

22. An electric grid comprising:
a plurality of grid sections;
at least one of the grid sections being a microgrid;
the microgrid configured to receive electric power from at least one of first and second grid power sources;
first and second grid-side converter for converting grid supplied AC to DC;
a first substation interconnecting the first converter to a first microgrid interconnection;
a second substation interconnecting the second converter to a second microgrid interconnection; and,
the microgrid having isolation devices for electrically isolating the microgrid from one or more sections of the grid.

23. The electric grid of claim 22 wherein the microgrid is also configured to export electric power from at least one of the AC to DC converters.

24. An electric grid comprising:
a plurality of grid sections;
at least one of the grid sections being a microgrid;
the microgrid supplying a plurality of loads;
a first substation and a first power source, the microgrid configured to receive electric power between the first substation and the first power source;
a second substation and a second power source, the microgrid configured to receive electric power at the second substation from the second power source;
the microgrid having isolation devices for electrically isolating the microgrid from one or more sections of the grid;
a master controller;
the master controller operative to communicate with at least one of an independent system operator, an electric utility company, and an electric power services aggregator; and,
the master controller operative to manage the microgrid based on information available to the master controller and user settings.

25. The electric grid of claim 24 further comprising:
the master controller operative to receive a load reduction command;
the master controller operative to select one or more microgrid loads to be curtailed and the corresponding power curtailments;
the master controller operative to select one or more microgrid local generators to be added and the corresponding power additions; and,
the master controller operative to achieve the commanded load reduction while meeting selected operating criteria.

26. The electric grid of claim 24 further comprising:
the master controller operative to reduce grid electric supply costs by requesting one or more microgrid loads to reduce their demand; and,
the master controller operative to reduce grid electric supply costs by requesting one or more local power sources to increase their output.

27. The electric grid of claim 24 further comprising:
the master controller operative to receive weather prediction information from a weather information source;
the master controller operative to determine if the severity of the predicted weather is likely to result in an electric power outage of an interconnected grid; and,
where the severity of the predicted weather is sufficient to result in an outage, the master controller is operative to disconnect the microgrid from interconnected grids and to dispatch one or more local power sources to serve at least some of the microgrid loads.

28. The electric grid of claim 24 further comprising:
a demand response mode implemented at least in part in the master controller;
the demand response mode operative to cause one or more microgrid loads to reduce their demand; and,
the demand response mode operative to cause dispatch of local generation to serve at least a part of the microgrid load.

29. The electric grid of claim 24 further comprising:
an autonomous healing function implemented at least in part in the master controller;
the autonomous healing function triggered by the parting of a distribution line, loss of power from a grid power source, or loss of power from a local power source; and,
the autonomous healing function operative to send commands to the substation breakers and sectionalizing switches that reestablish the power supply to one or more affected distribution lines.

30. The electric grid of claim 24 further comprising:
the master controller operative to receive environmental characteristics of the grid including one or more criteria pollutants and carbon production;
the master controller operative to compare the environmental characteristics of one or more microgrid local power sources with the grid environmental characteristics; and,
the master controller operative to dispatch one or more local power sources where such dispatch reduces the production of one or more of criteria pollutants and carbon.

31. The electric grid of claim 30 further comprising:
an outage database of weather related power outages and the corresponding measures of weather severity; and,
the outage likelihood determination being a function of the predicted weather severity as compared with the measures of weather severity in the outage database.

32. An electric grid comprising:
a microgrid powered from two sources;
the sources including a local generation source;
the microgrid capable of operating independently of one of the sources; and,
the microgrid including a self-healing function using sectionalizing switches and breakers to isolate a faulted distribution section and to redirect power to non-faulted sections after a fault occurs.

33. The electric grid of claim 32 further comprising an electric distribution system that is capable of operating on AC power that is synchronous with the grid.

34. The electric grid of claim 32 further comprising an electric distribution system that is capable of operating on AC power that is not synchronous with the grid and that is at a voltage different from that of the grid.

35. The electric grid of claim 32 further comprising an electric distribution system that is capable of operating on DC power.

36. The electric grid of claim 32 further comprising an electrical distribution system that is capable of operating solely on local generation by disconnecting itself electrically from the grid using breakers and switches.

37. The electric grid of claim 32 further comprising an electrical distribution system that is capable of operating solely on local generation by isolating itself from the grid using one or more converters.

38. The electric grid of claim 32 further comprising an electrical distribution system with an energy storage system that has at least enough energy storage capacity to supply power to critical loads on the microgrid for a period of time long enough to allow local generation or another back-up power source to supply power to the microgrid when power from the grid is not available.

39. The electric grid of claim 32 further comprising:
an electrical distribution system with a microgrid master controller
operative to control dependent control systems and local generation systems,
operative to coordinate autonomous microgrid load energy control systems,
operative to receive electric and fuel pricing information, weather data, and weather forecasts, and
operative to operate the microgrid to balance environmental, economic, security, and reliability benefits in light of microgrid operator preferences.

40. The electric grid of claim 32 further comprising:
local power sources including renewable energy sources; and,
wherein a master controller coordinates the actual and expected outputs of wind and solar generation to balance these outputs with microgrid loads.

41. The electric grid of claim 32 further comprising:
thermal energy produced by local power sources in the form of chilled water from absorption chillers, hot water, steam; and,
the master controller managing production and use of the thermal energy.

42. An electric grid comprising:
a plurality of grid sections;
at least one of the grid sections being a microgrid;
the microgrid configured to import electric power at first and second microgrid interconnections;
a first substation interconnecting the microgrid first interconnection with a first source of electric power;
a second substation interconnecting the microgrid second interconnection with a second source of electric power;
a combined heat and power system providing a third source of electric power local to the microgrid and for supplying the microgrid;
the combined heat and power system providing thermal energy to a building space associated with a microgrid load;
a master controller operative to isolate the microgrid from other grids in anticipation of a weather event determined by the master controller to have the capacity to cause a microgrid outage; and,
the microgrid having isolation devices for electrically isolating the microgrid from one or more sections of the grid.
